(19) United States
(12) Patent Application Publication
(10) Pub. No.: US 2023/0245549 A1
(43) Pub. Date: Aug. 3, 2023

(54) Systems and Methods for Dual Direction Individual Monitoring

(71) Applicant: BI Incorporated, Boulder, CO (US)

(72) Inventor: Dustin Pettit, Boulder, CO (US)

(73) Assignee: BI Incorporated, Boulder, CO (US)

(21) Appl. No.: 17/886,140

(22) Filed: Aug. 11, 2022

Related U.S. Application Data
(60) Provisional application No. 63/306,438, filed on Feb. 3, 2022.

(51) Int. Cl. G08B 21/22; H04W 4/029; H04N 5/262

(52) U.S. Cl. CPC G08B 21/22; H04W 4/029; H04N 5/2624

(57) ABSTRACT

Various embodiments provide systems and methods for video monitoring of individuals.

### CROSS REFERENCE TO RELATED APPLICATION

The present application claims priority to U.S. Provisional Application No. 63/306,438 entitled “Systems and Methods for Dual Direction Individual Monitoring” and filed Feb. 3, 2022 by Pettit. The entirety of the aforementioned reference is incorporated herein by reference for all purposes.

### BACKGROUND OF THE INVENTION

Various embodiments provide systems and methods for video monitoring of individuals.

Large numbers of individuals are currently monitored as part of parole requirements or other requirements. Such monitoring allows a monitoring agency to determine whether the individual is engaging in acceptable patterns of behavior, and where an unacceptable behavior is identified to stop such behavior going forward. It is common to monitor the individual, and this has provided reasonable feedback on the progress of the individual. That said, in many cases the individual's surroundings can be relevant to the individual's progress which is not addressed.

Thus, for at least the aforementioned reasons, there exists a need in the art for more advanced approaches, devices and systems for monitoring individuals.

### BRIEF SUMMARY OF THE INVENTION

Various embodiments provide systems and methods for video monitoring of individuals.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a is a block diagram illustrating a hybrid monitoring system including both a user attached monitor device and a user detached monitor device in accordance with various embodiments;

FIG. 1b is a block diagram of a user detached monitor device usable in accordance with one or more embodiments;

FIG. 1c is a block diagram of a user attached monitor device including a local communication link in accordance with some embodiments;

FIG. 1d shows a user attached monitor device with an attachment element for attaching the user attached monitor device to a limb of an individual in accordance with some embodiments;

FIG. 2 is a flow diagram showing a method in accordance with some embodiments from the perspective of a user detached monitor device for enabling single video image stream or two video image streams, and transmitting either the single video image stream from the user detached monitor device or two separate video images streams (e.g., a forward video image stream and a reverse video image steam) from the user detached monitor device based upon a received command;

FIG. 3 is a flow diagram showing a method in accordance with some embodiments from the perspective of a monitoring system interacting with the user detached monitor device of FIG. 2 including transmitting a command to select a single video image stream or two video image streams, and receiving either the single video image stream from the user detached monitor device or two separate video image streams (e.g., a forward video image stream and a reverse video image steam) and assembling the two separate video image streams into a single split screen video image stream, and displaying either the single video image stream or the a single split screen video image stream;

FIG. 4 is a flow diagram showing a method in accordance with some embodiments from the perspective of a user detached monitor device for enabling single video image stream or two video image streams, and transmitting either the single video image stream from the user detached monitor device, or combining two video image streams (e.g., a forward video image stream and a reverse video image steam) into a single split screen video image stream before transmitting to a monitoring system;

FIG. 5 is a flow diagram showing a method in accordance with some embodiments from the perspective of a monitoring system interacting with the user detached monitor device of FIG. 4 including transmitting a command to select a single video image stream or two video image streams, and receiving either the single video image stream from the user detached monitor device or the single split screen video image stream from the user detached monitor device;

FIG. 6a shows a monitored individual holding a user detached monitor device having two cameras, with one of the cameras pointed forward toward the face of the monitored individual (generating a forward video image stream) and the other of the two cameras pointed in reverse away from the face of the monitored individual (generating a reverse video image stream);

FIG. 6b shows the view of the camera pointed forward toward the face of the monitored individual (generating a forward video image stream) of FIG. 6a;

FIG. 6c shows the view of the camera pointed reverse away from the face of the monitored individual (generating a reverse video image stream) of FIG. 6a;

FIG. 6d shows a split screen video image stream showing the reverse view of FIG. 6c on the left and the forward view of FIG. 6b on the right, with a split screen video image stream being generated either by the monitor system receiving both the forward video image stream and the reverse video image stream as shown in the method of FIGS. 2-3, or the user detached monitor device generating a single split screen video image stream as shown in the method of FIGS. 4-5;

FIG. 7a shows a monitored individual in a room with another individual where the monitored individual is holding a user detached monitor device having two cameras, with one of the cameras pointed forward toward the face of the monitored individual (generating a forward video image stream) and the other of the two cameras pointed in reverse away from the face of the monitored individual (generating a reverse video image stream);

FIG. 7b shows the view of the camera pointed forward toward the face of the monitored individual (generating a forward video image stream) of FIG. 7a;

FIG. 7c shows the view of the camera pointed reverse away from the face of the monitored individual (generating a reverse video image stream) of FIG. 7a; and

FIG. 7d shows a split screen video image stream showing the reverse view of FIG. 7c on the left and the forward view of FIG. 7b on the right, with a split screen video image stream being generated either by the monitor system receiving both the forward video image stream and the reverse video image stream as shown in the method of FIGS. 2-3, or the user detached monitor device generating a single split screen video image stream as shown in the method of FIGS. 4-5.

### DETAILED DESCRIPTION OF THE INVENTION

Various embodiments provide systems and methods for video monitoring of individuals.

It has been found that returning offenders to society after being locked up in a secure facility with little if any control of their day to day activities is often unsuccessful. It can be helpful to have, for example, a parole officer monitor their movements and activities for a period of time as they reenter society. In some cases, the parole officer is aided by a tracking device attached to the individual being monitored, or by a portable device typically maintained with the individual but not necessarily attached to the individual.

Some embodiments provide systems for receiving first video images of an individual being monitored and second video images showing surroundings of the individual being monitored. In some instances of the aforementioned embodiments, both the first video images and the second video images are captured by the same user detached monitor device. In various such instances, the user detached monitor device is a mobile phone.

Various embodiments provide systems for monitoring an individual. The systems include a user detached monitor device. The user detached monitor device includes: a first camera facing a first direction relative to the user detached monitor device; a second camera facing a second direction relative to the user detached monitor device; a processor; and a computer readable medium. The computer readable medium includes instructions executable by the processor to: receive a command that indicates either single camera operation or dual camera operation; transmit a first video image stream from the first camera when the command indicates single camera operation; and transmit a second video image stream derived from the first camera and the second camera when the command indicates dual camera operation. In some instances of the aforementioned embodiments, the first direction is approximately 180 degrees from the second direction.

In various instances of the aforementioned embodiments, transmitting the second video image stream derived from the first camera and the second camera includes combining a video image stream from the first camera with a video image stream from the second camera to yield a split screen video image stream. In some such instances, the split screen video image stream includes approximately even portions of the video image stream from the first camera and the video image stream from the second camera. In other such instances, the split screen video image stream includes one of the video image stream from the first camera or the video image stream from the second camera as a picture-in-picture overlay on the other of the video image stream from the first camera or the video image stream. In some instances of the aforementioned embodiments, transmitting the second video image stream derived from the first camera and the second camera includes transmitting both the first video image stream from the first camera and a third video image stream from the second camera as separate video streams.

Other embodiments provide methods for monitoring an individual, the methods include: receiving, by a processing resource of a user detached monitor device, an indication of either single camera operation or dual camera operation; transmitting, by the processing resource of the user detached monitor device, a first video image stream from a first camera of a user detached monitor device when the command indicates single camera operation; and transmitting, by the processing resource of the user detached monitor device, a second video image stream derived from the first camera and the second camera of the user detached monitor device when the command indicates dual camera operation, wherein the first camera is directed in a first direction and the second camera is directed in a second direction. In some instances of the aforementioned embodiments the indication is one of: an input from a monitored individual associated with the user detached monitor device; a command received from a third party assigned to monitor the monitored individual, or a preset field in the user detached monitor device.

Yet other embodiments provide systems for monitoring an individual. The systems include a user detached monitor device that has: a first camera facing a first direction relative to the user detached monitor device; a second camera facing a second direction relative to the user detached monitor device; a processor; and a computer readable medium. The computer readable medium includes instructions executable by the processor to: select processing using only a single video stream or multiple video streams based upon an input; transmit a first video image stream from the first camera when the command indicates single camera operation; and transmit a second video image stream derived from the first camera and the second camera when the command indicates dual camera operation. In some instances of the aforementioned embodiments, the input is one of an input from a monitored individual associated with the user detached monitor device; a command received from a third party assigned to monitor the monitored individual, or a preset field in the user detached monitor device.

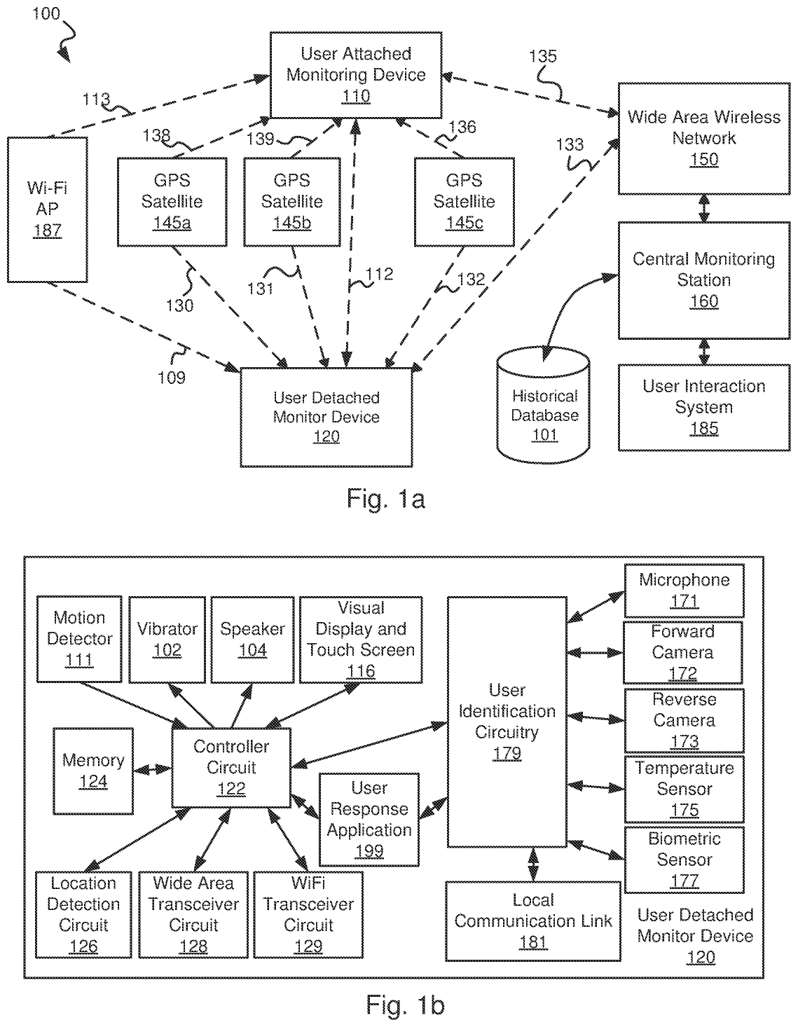

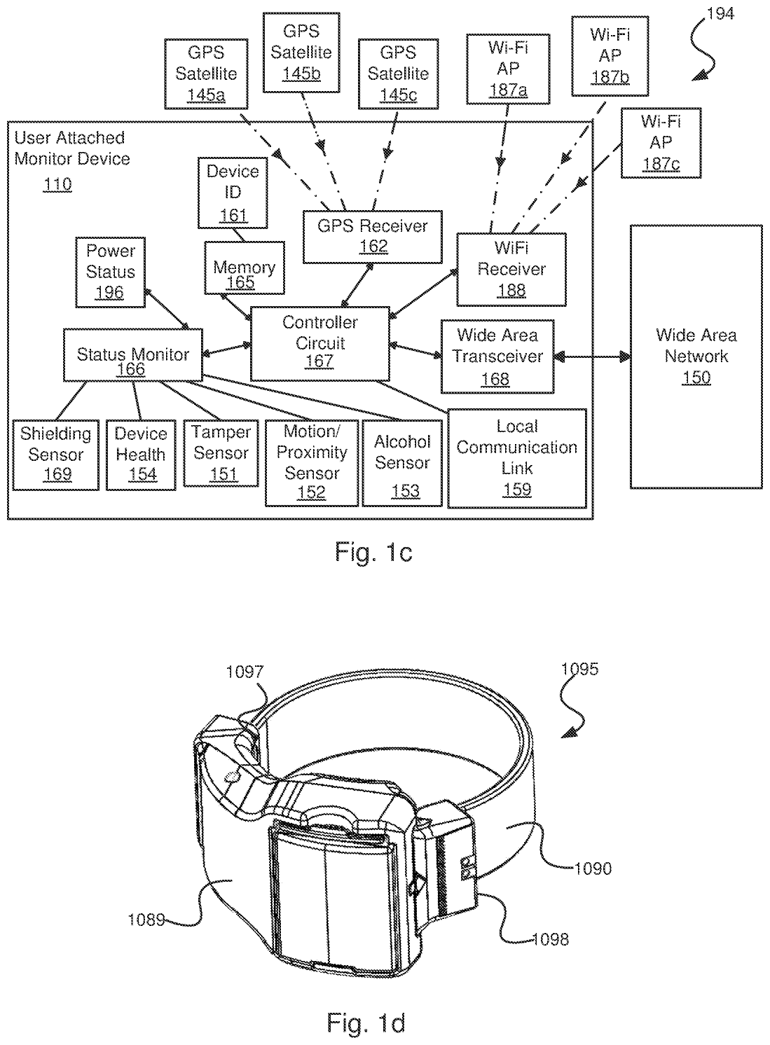

Turning to FIG. 1a, a block diagram illustrates a hybrid monitoring system 100 including both a user attached monitor device 110 and a user detached monitor device 120 in accordance with various embodiments. A local communication link 112 allows for communication between user attached monitor device 110 and user detached monitor device 120. Local communication link 112 may be any communication link that is capable of transferring information or otherwise communicating between two devices within a relatively short distance of each other. In some cases, for example, local communication link 112 may be a Bluetooth™ communication link. In other examples, local communication link 112 may be a line of sight infrared communication link. As yet other examples, local communication link 112 may be a WiFi communication link. Based upon the disclosure provided herein, one of ordinary skill in the art will recognize a variety of communication protocols and/or media that may be used to implement local communication link 112.

User detached monitor device 120 is portable, and may be any device that is recognized as being used by or assigned to an individual being monitored, but is not physically attached to the individual being monitored by a tamper evident attaching device. User detached monitor device 120 may be, but is not limited to, a cellular telephone capable of communication with user attached monitor device 110 via local communication link 112. In contrast, user attached monitor device 110 is attached to the individual being monitored using a tamper evident attaching device like a strap. User attached monitor device 110 may be, but is not limited to, a tracking device that is attached around the limb of an individual and includes indicators to monitor whether the device has been removed from the individual or otherwise tampered. Hybrid monitoring system 100 further includes a central monitoring station 160 wirelessly coupled to user attached monitor device 110 and user detached monitor device 120 via one or more wide area wireless (e.g., cellular telephone network. Internet via a Wi-Fi access point, or the like) communication networks 150.

User detached monitor device 120 includes a location sensor that senses the location of the device and generates a location data. For example, when user detached monitor device 120 is capable of receiving wireless global navigation satellite system (hereinafter “GNSS”) location information 130, 131, 132 from a sufficient number of GPS or GNSS satellites 145 respectively, user detached monitor device 120 may use the received wireless GNSS location information to calculate or otherwise determine the location of user attached monitor device 110. Global positioning system (hereinafter “GPS) is one example of a GNSS location system. While GPS is used in the specific embodiments discussed herein, it is recognized that GPS may be replaced by any type of GNSS system. In some instances, this location includes latitude, longitude, and elevation. It should be noted that other types of earth-based triangulation may be used in accordance with different embodiments of the present invention. For example, other cell phone based triangulation, UHF band triangulation such as, for example, long range (hereinafter “LoRa”) triangulation signals. Based on the disclosure provided herein, one of ordinary skill in the art will recognize other types of earth-based triangulation that may be used. The location data may comprise one or more of, but is not limited to: global positioning system (“GPS”) data, Assisted GPS (“A-GPS”) data, Advanced Forward Link Trilateration (“AFLT”) data, and/or cell tower triangulation data. Where GPS is used, user detached monitor device 120 receives location information from three or more GPS satellites 145a, 145b, 145c via respective communication links 130, 131, 132. The aforementioned location data is utilized to verify the location of a monitored individual associated with user detached monitor device 120 at various points as more fully discussed below. User detached monitor device 120 is considered “ambiguous” because it is not attached to the monitored individual in a tamper resistant/evident way, but rather is freely severable from the monitored individual and thus could be used by persons other than the monitored individual. Various processes discussed herein mitigate the aforementioned ambiguity to yield a reasonable belief that information derived from user detached monitor device 120 corresponds to the monitored individual.

The location data and/or other data gathered by user detached monitor device 120 is wirelessly transmitted to central monitoring station 160 via wide area wireless network 150 accessed via a wireless link 133. Central monitoring station 160 may be any location, device or system where the location data is received, including by way of non-limiting example: a cellular/smart phone, an email account, a website, a network database, and a memory device. The location data is stored by central monitoring station 160 and is retrievable by a monitor, such as a parent, guardian, parole officer, court liaison, spouse, friend, or other authorized group or individual. In this manner, the monitor is able to respond appropriately to the detected out-of-bounds activity by a monitored individual. In some cases, the monitor is able to retrieve the location data via a user interaction system 185 which may be, but is not limited to, a network connected user interface device communicatively coupled via a network to central monitoring station 160 and/or directly to user detached monitor device 120 via wide area wireless network 150.

User detached monitor device 120 may further include a user identification sensor operable to generate user identification data for identifying the monitored individual in association with the generation of the location data. The user identification data may comprise one or more of: image data, video data, biometric data (e.g. fingerprint, DNA, retinal scan, facial recognition, etc. data), or any other type of data that may be used to verify the identity of the monitored individual at or near the time the location data is generated. And the user identification sensor may comprise one or more of: a camera, microphone, heat sensor, biometric data sensor, or any other type of device capable of sensing/generating the aforementioned types of user identification data.

The user identification data is wirelessly transmitted in association with the location data to central monitoring station 160 via a wireless transmitter communicatively coupled to the user identification sensor. The user identification data is stored in association with the location data by central monitoring station 160 and is retrievable therefrom by a monitor, such as a parent, guardian, parole officer, court liaison, spouse, friend, or other authorized group or individual. Preferably, the monitor is able to retrieve the location data via a network connected user interface device communicatively coupled—via the network—to central monitoring station 160 and/or to user detached monitor device 120. The location data may be transmitted to central monitoring station 160 independent of the user identification data, for example, during a periodic check-in with central monitoring system 160.

User detached monitor device 120 may further comprise a memory communicatively coupled to a control unit—which is also communicatively coupled to the location sensor, the identification sensor and the wireless transceiver—for controlling the operations thereof in accordance with the functionalities described herein. The memory may include non-transient instructions (e.g., software of firmware-based based instructions) executable by the control unit to perform and/or enable various functions associated with user detached monitor device 120. As user detached monitor device 120 is portable, each of the components may be located within, immediately adjacent to, or exposed without, a device housing whose dimensions are such that user detached monitor device 120 as a whole may be discretely carried by the user, for example, within a pocket or small purse. User detached monitor device 120 may include a Wi-Fi transceiver capable of receiving information from one or more Wi-Fi access points 187 that can be used to discern location via a Wi-Fi communication link 109.

Central monitoring station 160 may include a server supported website, which may be supported by a server system comprising one or more physical servers, each having a processor, a memory, an operating system, input/output interfaces, and network interfaces, all known in the art, coupled to the network. The server supported website comprises one or more interactive web portals through which the monitor may monitor the location of the monitored individual in accordance with the described embodiments. In particular, the interactive web portals may enable the monitor to retrieve the location and user identification data of one or more monitored individuals, set or modify ‘check-in’ schedules, and/or set or modify preferences. The interactive web portals are accessible via a personal computing device, such as for example, a home computer, laptop, tablet, and/or smart phone.

In some embodiments, the server supported website comprises a mobile website or mobile application accessible via a software application on a mobile device (e.g. smart phone). The mobile website may be a modified version of the server supported website with limited or additional capabilities suited for mobile location monitoring.

User attached monitor device 110 includes a location sensor that senses the location of the device and generates a location data. For example, when user attached monitor device 110 is capable of receiving wireless global navigation satellite system (hereinafter “GNSS”) location information 136, 138, 139 from a sufficient number of GPS or GNSS satellites 145 respectively, user attached monitor device may use the received wireless GNSS location information to calculate or otherwise determine the location of human subject 110. Global positioning system (hereinafter “GPS) is one example of a GNSS location system. While GPS is used in the specific embodiments discussed herein, it is recognized that GPS may be replaced by any type of GNSS system. In some instances, this location includes latitude, longitude, and elevation. It should be noted that other types of earth-based triangulation may be used in accordance with different embodiments of the present invention. For example, other cell phone based triangulation, UHF band triangulation such as, for example, long range (hereinafter “LoRa”) triangulation signals. Based on the disclosure provided herein, one of ordinary skill in the art will recognize other types of earth-based triangulation that may be used. The location data may comprise one or more of, but is not limited to: global positioning system (“GPS”) data, Assisted GPS (“A-GPS”) data, Advanced Forward Link Trilateration (“AFLT”) data, and/or cell tower triangulation data. Where GPS is used, user attached monitor device 110 receives location information from three or more GPS or GNSS satellites 145 via respective communication links 136, 138, 139. The location data and/or other data gathered by user attached monitor device 110 is wirelessly transmitted to central monitoring station 160 via wide area wireless network 150 accessed via a wireless link 135. Again, central monitoring station 160 may be any location, device or system where the location data is received, including by way of non-limiting example: a cellular/smart phone, an email account, a website, a network database, and a memory device. The location data is stored by central monitoring station 160 and is retrievable by a monitor, such as a parent, guardian, parole officer, court liaison, spouse, friend, or other authorized group or individual. In this manner, monitor is able to respond appropriately to the detected out-of-bounds activity by a monitored individual.

User attached monitor device 110 may further comprise a memory communicatively coupled to a control unit—which is also communicatively coupled to the location sensor, the identification sensor and the wireless transceiver—for controlling the operations thereof in accordance with the functionalities described herein. The memory may include non-transient instructions (e.g., software of firmware-based based instructions) executable by the control unit to perform and/or enable various functions associated with user attached monitor device 110. User attached monitor device may include a strap which can be wrapped around a limb of the individual being monitored to secure user attached monitor device to the monitored individual. The strap includes one or more tamper circuits and/or sensors that allow for a determination as to whether the device has been removed or otherwise tampered. Examples of a strap and tamper detection circuitry that may be used in relation to various embodiments discussed herein are described in U.S. Pat. No. 9,355,579 entitled “Methods for Image Based Tamper Detection”, and filed by Buck et al. on Sep. 15, 2014; and US Pat. Pub. No. US 2017-0270778 A1 entitled “Systems and Methods for Improved Monitor Attachment”, and filed by Melton et al. on Mar. 21, 2016. Both of the aforementioned references are incorporated herein by reference for all purposes. Based upon the disclosure provided herein, one of ordinary skill in the art will recognize a variety of straps, tamper circuits, tamper devices, and/or attachment and tamper detection approaches that may be used in relation to various embodiments. User attached monitor device 110 may include a Wi-Fi transceiver capable of receiving information from one or more Wi-Fi access points 187 that may be used to identify location via a Wi-Fi communication link 113.

Central monitoring station 160 is communicably coupled to a historical database 101. Historical database 101 includes a variety of data corresponding to a monitored individual including, but not limited to, types of addictions and problems that the individual has had in the past, last incident of substance abuse and the type of substance used, physical locations visited by the monitored individual during a previous time period, other monitored individuals that the monitored individual has been in proximity to and the types of addictions and problems that the other monitored individuals have had in the past, triggering events that have preceded prior addiction relapses of the monitored individual, and/or recent scenarios that are similar to prior triggering events. Based upon the disclosure provided herein, one of ordinary skill in the art will recognize other historical data related to a monitored individual that may be maintained in historical database in accordance with various embodiments.

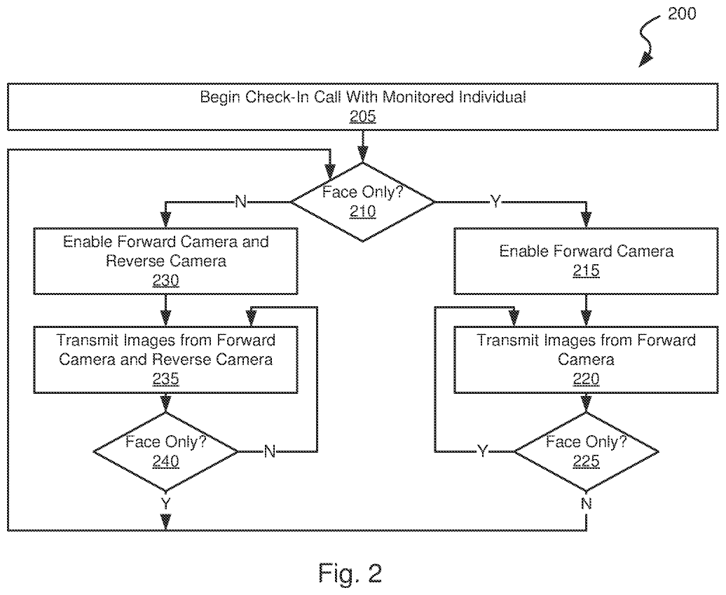

Turning to FIG. 1b, a block diagram of user detached monitor device 120 is shown in accordance with one or more embodiments. User detached monitor device 120 includes wireless transceiver circuitry 128 that is capable of sending and receiving information via wireless link 133 to/from wide area wireless network 150. Wireless transceiver circuitry 128 may be any circuitry, integrated circuit, and/or processor or controller capable of supporting wireless communication. Such wireless communication may include, but is not limited to, cellular telephone communication, Internet communication via a Wi-Fi access point, or both. In addition, user detached monitor device 120 includes a vibrator 112, a speaker 114, and a visual display and touch screen 116. In some cases, at scheduled times a monitored individual associated with user detached monitor device 120 is alerted of a need to check-in. The schedule of check-in times may be downloaded to a memory 124 by central monitoring station 160 via wireless link 133. The monitored individual may be alerted by one or more of: a visual prompt via visual display and touch screen 116, an audio prompt via speaker 114, and a tactile prompt via vibrator 112. Each of vibrator 112, speaker 114, and visual display and touch screen 116 is communicatively coupled to memory 124 and/or a controller circuit 122 for controlling the operations thereof. In some cases, controller circuit 122 includes a processor. In various cases, controller circuit 122 is part of an integrated circuit. In one or more cases, memory 124 is included in an integrated circuit with controller circuit 122. In various cases, memory 124 may include non-transient instructions (e.g., software or firmware-based based instructions) executable by controller circuit 122 to perform and/or enable various functions associated with user detached monitor device 120. In some embodiments, controller circuit 122 executes instructions that enable the dual view call in approaches discussed below in relation to FIGS. 2-5.

A visual prompt may include, but is not limited to, text, images and/or a combination thereof, or a series of such visual prompts. An audio prompt may include, but is not limited to, one or more different audio prompts, or a series thereof. Each prompt may be stored in memory 124 and retrieved in accordance with the schedule that is also maintained in memory 124. In some embodiments, alerting the monitored individual involves a prompt that includes an e-mail or text message generated by central monitoring station 160 (e.g. the server supported website) and transmitted to the e-mail account or cellular phone number corresponding to user detached monitor device 120. In particular embodiments, such a prompt may include a ‘post’ on the user's ‘wall,’ ‘feed,’ or other social networking privilege. In some embodiments, the prompt may comprise an automated or live phone call to the monitored individual.

User detached monitor device 120 further includes user identification circuitry 179 capable of gathering user identification information from one or more of a microphone 171, a camera 173, a temperature sensor 175, and/or a biometric sensor 177. In some cases, user identification circuitry 179 is incorporated in an integrated circuit with controller circuit 122. Microphone 171 is capable of accurately capturing the sound of a monitored individual's voice, camera 173 is capable of accurately capturing images including, for example, an image of the monitored individual's face, temperature sensor 175 is capable of accurately capturing an ambient temperature around user detached monitor device 120, and biometric sensor 177 is capable of accurately capturing biometric data about the monitored individual including, but not limited to, a thumb print, a retinal scan, or a breath-based alcohol measurement. Based upon the disclosure provided herein, one of ordinary skill in the art will recognize a variety of biometric data and corresponding sensors that may be used in relation to different embodiments. Under the direction of control circuitry 122, user identification circuitry 179 assembles one or more elements of data gathered by microphone 171, a camera 173, a temperature sensor 175, and/or a biometric sensor 177 into a user identification package which is forwarded to central monitoring station 160 via wireless transceiver circuitry 128. User detached monitor device 120 additionally includes a motion detector 111 operable to discern whether user detached monitor device is moving. In some cases, motion detector 120 includes an accelerometer circuit. Based upon the disclosure provided herein, one of ordinary skill in the art will recognize various circuits and/or sensors capable of indicating that user detached monitor device is moving that may be used in relation to different embodiments.

User detached monitor device 120 additionally includes location circuitry 126. Location circuitry 126 may include one or more of, a GPS processing circuit capable of fixing a location of user detached monitor device 120 using GPS data, a WiFi based location circuit capable of fixing a location of user detached monitor device 120 using contact information with one or more WiFi access points, and/or a cell tower triangulation processing circuit capable of fixing a location of user detached monitor device 120 using cell tower triangulation data. A local communication link 181 controls communication between user detached monitor device 120 and user attached monitor device 110. In some embodiments, local communication link 181 supports a Bluetooth™ communication protocol and is capable of both receiving information from user attached monitor device 110 and transmitting information to user attached monitor device 110. In other embodiments, local communication link 181 supports a Wi-Fi communication protocol and is capable of both receiving information from user attached monitor device 110 and transmitting information to user attached monitor device 110. In some cases, local communication link 181 supports communication in only a receive or transmit direction. Based upon the disclosure provided herein, one of ordinary skill in the art will recognize a variety of communication protocols and information transfer directions that may be supported by local communication link 181 in accordance with different embodiments.

Additionally, user detached monitor device 120 includes a user response application 199 that controls operation of one or more user impairment detection tests administered using user detached monitor device 120 and/or user attached monitor device 110, and/or one or more diagnostic tests. In some embodiments, such impairment tests may be implemented similar to that discussed in US Pat. Pub. No. US2020/0367801 entitled “Systems and Methods for Balance Deviation Detection in a Monitoring System” and filed Mar. 17, 2020 by Hanson et al. The entirety of the aforementioned reference is incorporated herein by reference for all purposes. In some embodiments, such diagnostic tests may be implemented similar to that discussed in U.S. patent Ser. No. 10/893,383 entitled “Systems and Methods for Monitoring System Equipment Diagnosis” and filed May 6, 2019 by Buck et al. The entirety of the aforementioned reference is incorporated herein by reference for all purposes.

Turning to FIG. 1c, a block diagram 194 of user attached monitor device 110 including a local communication link 159 is shown in accordance with some embodiments. Local communication link 159 controls communication between user attached monitor device 110 and user detached monitor device 120. In some embodiments, local communication link 159 supports a Bluetooth™ communication protocol and is capable of both receiving information from user detached monitor device 120 and transmitting information to user detached monitor device 120. In other embodiments, local communication link 159 supports a Wi-Fi communication protocol and is capable of both receiving information from user detached monitor device 120 and transmitting information to user detached monitor device 120. In some cases, local communication link 159 supports communication in only a receive or transmit direction. Based upon the disclosure provided herein, one of ordinary skill in the art will recognize a variety of communication protocols and information transfer directions that may be supported by local communication link 159 in accordance with different embodiments.

As shown, user attached monitor device 110 includes a device ID 161 that may be maintained in a memory 165, and is thus accessible by a controller circuit 167. Controller circuit 167 is able to interact with a GPS receiver 162 and memory 165 at times for storing and generating records of successively determined GPS locations. Similarly, controller circuit 167 is able to interact with a Wi-Fi receiver 188 and memory 165 at times for storing and generating records of successively determined Wi-Fi access point identifications and signal strength. In some cases, memory 165 may include non-transient instructions (e.g., software of firmware-based based instructions) executable by controller circuit 167 to perform and/or enable various functions associated with user attached monitor device 110. As user attached monitor device 110 comes within range of one or more Wi-Fi access points (e.g., Wi-Fi access points 187), a Wi-Fi receiver 188 senses the signal provided by the respective Wi-Fi access points, and provides an identification of the respective Wi-Fi access point and a signal strength of the signal received from the Wi-Fi access point to Wi-Fi receiver 188. This information is provided to controller circuit 167 which stores the information to memory 165.

Where user attached monitor device 110 is operating in a standard mode, controller circuit 167 causes an update and reporting of the location of user attached monitor device 110 via a wide area transceiver 168 and wide area communication network 150. In some embodiments, wide area transceiver 168 is a cellular telephone transceiver. In some cases, the location data is time stamped. In contrast, where user attached monitor device 110 is within range of a public Wi-Fi access point, reporting the location of user attached monitor device 110 may be done via the public Wi-Fi access point in place of the cellular communication link. In another case where user attached monitor device 110 is operating in a low battery mode, reporting the location of user attached monitor device 110 may be done via user detached monitoring device 120 coupled using local communication link 159.

Which technologies are used to update the location of user attached monitor device 110 may be selected either by default, by programming from central monitor station 160, or based upon sensed scenarios with corresponding pre-determined selections. For example, it may be determined whether sufficient battery power as reported by power status 196 remains in user attached monitor device 110 to support a particular position determination technology. Where insufficient power remains, the particular technology is disabled. In some cases, a maximum cost of resolving location may be set for user attached monitor device 110. For example, resolving Wi-Fi location data may incur a per transaction cost to have a third-party service provider resolve the location information. When a maximum number of resolution requests have been issued, the Wi-Fi position determination technology may be disabled. Further, it may be determined whether the likelihood that a particular position determination technology will be capable of providing meaningful location information. For example, where user attached monitor device 110 is moved indoors, GPS receiver 162 may be disabled to save power. Alternatively, where the tracking device is traveling at relatively high speeds, the Wi-Fi receiver 188 may be disabled. As yet another example, where cellular phone jamming is occurring, support for cell tower triangulation position determination may be disabled. As yet another example, where GPS jamming is occurring, GPS receiver 162 may be disabled. As yet another example, where user attached monitor device 110 is stationary, the lowest cost (from both a monetary and power standpoint) tracking may be enabled while all other technologies are disabled. Which position determination technologies are used may be based upon which zone a tracking device is located. Some zones may be rich in Wi-Fi access points and in such zones Wi-Fi technology may be used. Otherwise, another technology such as cell tower triangulation or GPS may be used. Based upon the disclosure provided herein, one of ordinary skill in the art will recognize other scenarios and corresponding combinations of technologies may be best.

Controller circuit 167 of user attached monitor device 110 at times functions in conjunction with wide area transceiver 168 to send and receive data and signals through wide area communication network 150. This link at times is useful for passing information and/or control signals between a central monitoring system (not shown) and user attached monitor device 110. The information transmitted may include, but is not limited to, location information, alcohol information, and information about the status of user attached monitor device 110. Based on the disclosure provided herein, one of ordinary skill in the art will recognize a variety of information that may be transferred via wide area communication network 150.

Various embodiments of user attached monitor device 110 include a variety of sensors capable of determining the status of user detached monitor device 120, and of the individual associated therewith. For example, a status monitor 166 may include one or more of the following subcomponents: power status sensor 196 capable of indicating a power status of user detached monitor device 120. The power status may be expressed, for example as a percentage of battery life remaining. Based upon the disclosure provided herein, one of ordinary skill in the art will recognize a variety of forms in which power status may be expressed. In addition, user attached monitor device 110 includes a set of shielding sensors 169 that are capable of determining whether user attached monitor device 110 is being shielded from receiving GPS signals and/or if GPS jamming is ongoing, a set of device health indicators 154, a tamper sensor 131 capable of determining whether unauthorized access to user attached monitor device 110 has occurred or whether user attached monitor device 110 has been removed from an associated individual being monitored, a motion/proximity sensor 152 capable of determining whether user attached monitor device 110 is moving and/or whether it is within proximity of an individual associated with user detached monitor device 120, and/or an alcohol sensor 153. Such an alcohol sensor may be any alcohol sensor capable of estimating an amount of alcohol in the individual being monitored. Based upon the disclosure provided herein, one of ordinary skill in the art will recognize a variety of alcohol sensors and corresponding alcohol sensing circuitry that may be used in relation to different embodiments. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into user attached monitor device 110 according to various different instances and/or embodiments.

Turning to FIG. 1d, a user attached monitor device 1089 is shown with an example attachment element 1090 connected at opposite ends of user attached monitor device 1089 (i.e., a first end 1097 and a second end 1098). Attachment element 1090 is operable to securely attach a tracking device 1095 (i.e., a combination of user attached monitor device 1089 and attachment element 1090) to a limb of an individual in accordance with some embodiments. In various embodiments, attachment element 1090 includes electrically and/or optically conductive material used to make a conductive connection form first end 1097 to second end 1098 through attachment element 1090 and is used in relation to determining whether user attached monitor device 1089 remains attached and/or has been tampered with. While FIG. 1d shows a strap as an example attachment element, based upon the disclosure provided herein, one of ordinary skill in the art will recognize other types of attachment elements that may be used in relation to different embodiments.

Turning to FIG. 2, a flow diagram 200 shows a method in accordance with some embodiments from the perspective of a user detached monitor device for enabling single video image stream or two video image streams, and transmitting either the single video image stream from the user detached monitor device or two separate video images streams (e.g., a forward video image stream and a reverse video image steam) from the user detached monitor device. Following flow diagram 200, a check-in call is initiated with a monitored individual (block 205). Such a check-in call may be initiated, for example, by a third party calling a user detached monitor device associated with the monitored individual. As another example, such a check-in call may be initiated automatically by a user detached monitor device associated with the monitored individual based upon a check-in schedule maintained in the user detached monitor device. As yet another example, such a check-in call may be initiated by the monitored individual using a user detached monitor device associated with the monitored individual to call a designated third party. Based upon the disclosure provided herein, one of ordinary skill in the art will recognize a variety of approaches that may be used to initiate a check-in in accordance with different embodiments.

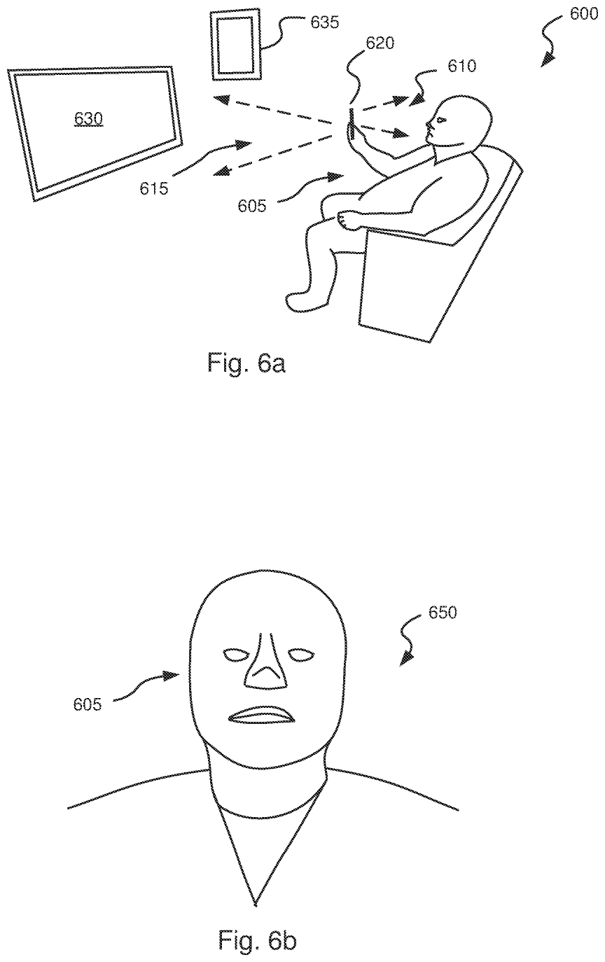

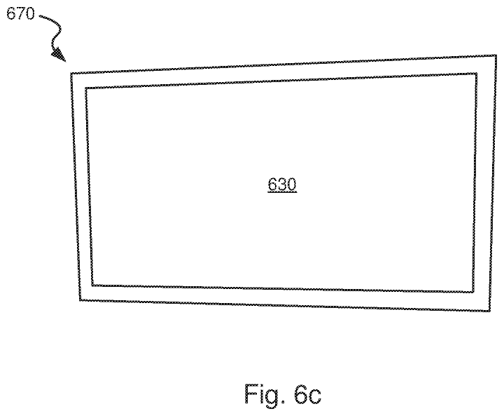

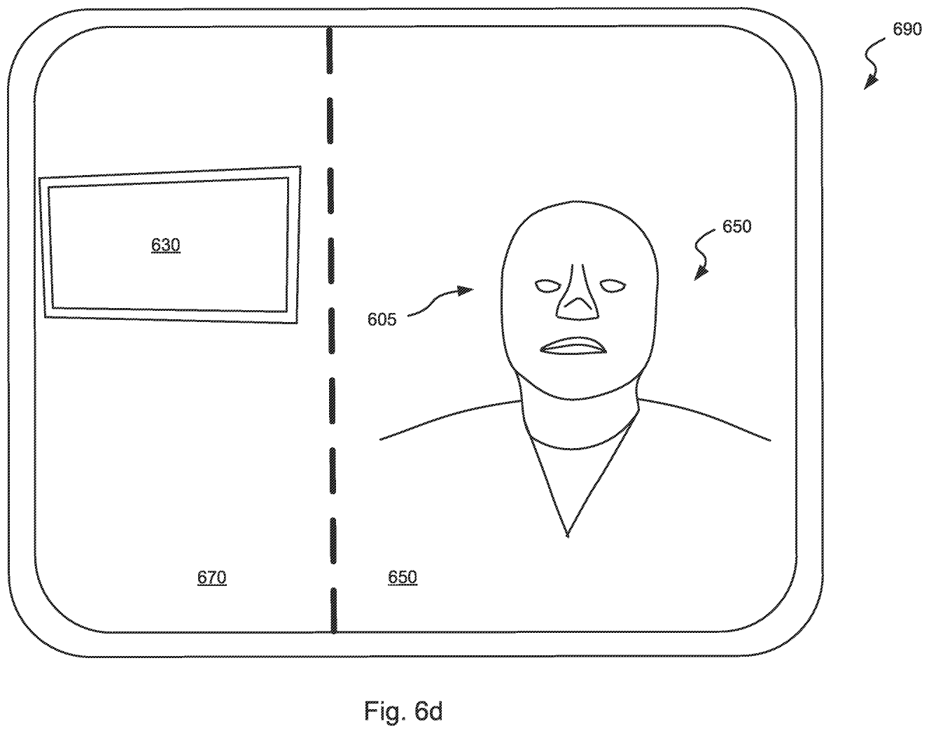

Turning to FIG. 6a, a monitored individual 605 is shown holding a user detached monitor device 620 having two cameras, with one of the cameras pointed forward toward the face monitored individual 605 (generating a forward video image stream corresponding to a forward field of view 610) and the other of the two cameras pointed in reverse away from the face of monitored individual 605 (generating a reverse video image stream corresponding to a reverse field of view 615). The forward field of view shows primarily monitored individual 605, and reverse field of view 615 shows various surroundings (e.g., a television 630) of monitored individual 605. A picture 635 is not in either forward field of view 610 or reverse field of view 615.

Returning to FIG. 2, it is determined whether the check-in will be performed with images of only the monitored individual's face (block 210). This may be determined, for example, based upon a preset configuration in the user detached monitor device. Alternatively, this may be determined, for example, based upon a command received from the third party with whom the monitored individual is checking in. Such a command from the third party may be directed either directly to the user attached monitor device associated with the monitored individual such that the monitored individual is not involved in the selection, or to the monitored individual who then enters the selection in the user detached monitor device. Based upon the disclosure provided herein, one of ordinary skill in the art will recognize a variety of approaches for determining whether only a face image of the monitored individual is to be used in accordance with different embodiments.

Where only a face image is selected (block 210), a forward camera on the user detached monitor device is enabled (block 215), and a video stream derived from the enabled forward camera is generated by the user detached monitor device and transmitted to the third party with whom the monitored individual is checking in (block 220). Such transmission of images may be done using any approach known in the art. Turning to FIG. 6b, an example forward video stream 650 corresponding to forward field of view 610 of monitored individual 605 of FIG. 6a is shown. This is an example of the single video stream transmitted when face only is selected.

Returning to FIG. 2, where only a face image is not selected (block 210), both the forward camera and a reverse camera on the user detached monitor device are enabled (block 230), and a dual video stream derived from the enabled forward camera and the enabled reverse camera is generated by the user detached monitor device and transmitted to the third party with whom the monitored individual is checking in (block 235). The dual video stream transmitted as two individual video streams—one from the enabled forward camera and the other from the enabled reverse camera. Turning to FIG. 6c, an example reverse video stream 670 corresponding to reverse field of view 615 of monitored individual 605 of FIG. 6a is shown. This is an example of the reverse image that is transmitted along with the forward image that are transmitted when face only is not selected.

Returning to FIG. 2, the selection of only a face image is continually monitored (blocks 210, 225, 240). At any point that the selection is changed from face only to not face only, both the forward and reverse cameras are enabled (block 230), and dual video streams are sent (block 235). Similarly, at any point that the selection is changed to face only from not face only, the reverse camera is disabled and only the forward camera is enabled (block 215), and only a single video stream is sent (block 220).

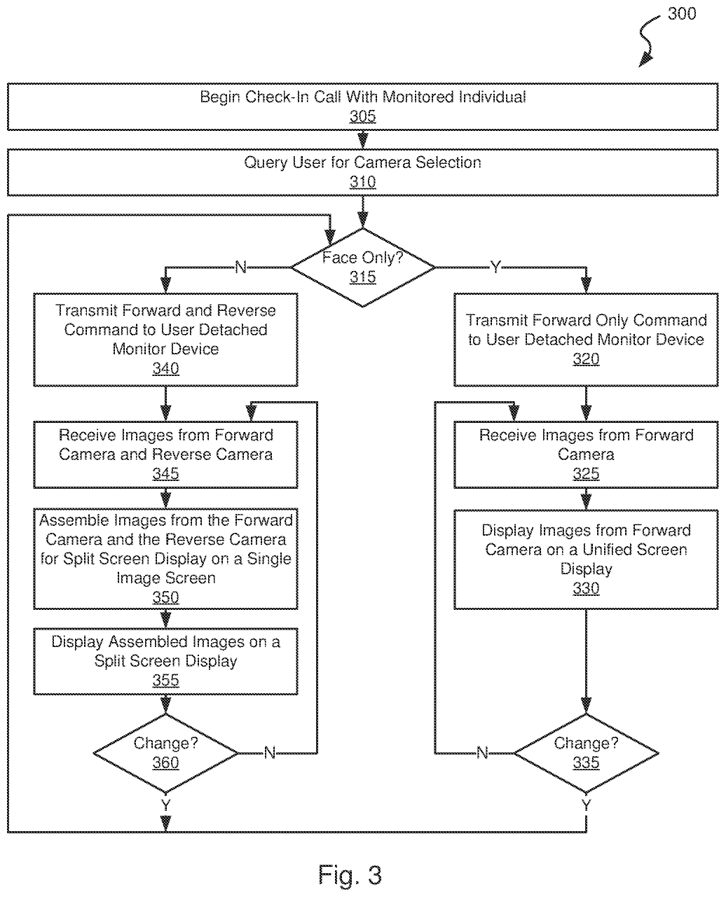

Turning to FIG. 3, a flow diagram 300 shows a method in accordance with some embodiments from the perspective of a monitoring system interacting with the user detached monitor device of FIG. 2. Following flow diagram 300, a check-in call is initiated with a monitored individual (block 305). Such a check-in call may be initiated, for example, by a third party calling a user detached monitor device associated with the monitored individual. As another example, such a check-in call may be initiated automatically by a user detached monitor device associated with the monitored individual based upon a check-in schedule maintained in the user detached monitor device. As yet another example, such a check-in call may be initiated by the monitored individual using a user detached monitor device associated with the monitored individual to call a designated third party. Based upon the disclosure provided herein, one of ordinary skill in the art will recognize a variety of approaches that may be used to initiate a check-in in accordance with different embodiments.

The monitoring system queries the third party performing the monitoring on the monitored individual if they would like a face only monitoring check-in or if they would like more than a face only (block 310). This can be done, for example, by presenting a prompt to a user station accessed by the third party. It is determined whether the check-in will be performed with images of only the monitored individual's face based upon the response to the query provided to the third party (block 315).

Where only a face image is selected (block 315), a command is transmitted to the user detached monitor device used by the monitor individual to enable only the forward camera of the user detached monitor device (block 320). Once the command is implemented by the user detached monitor device, a video stream is received from the forward camera of the user detached monitor device (block 325). Turning to FIG. 6b, example forward video stream 650 corresponding to forward field of view 610 of monitored individual 605 of FIG. 6a is shown. This is an example of the single video stream transmitted when face only is selected. Returning to FIG. 3, the video images from the forward camera are displayed on a display (a unified screen display showing only the single video stream from the forward camera of the user detached monitor device) used by the third party (block 330).

Alternatively, where only a face image is not selected (block 315), a command is transmitted to the user detached monitor device used by the monitor individual to enable both the forward camera and the reverse camera of the user detached monitor device (block 340). Once the command is implemented by the user detached monitor device, a video stream is received from the forward camera of the user detached monitor device and a separate video stream is received from the reverse camera of the user detached monitor device (block 345). The video streams from each of the forward camera and the reverse camera are assembled for a split screen display (block 350). Turning to FIG. 6d, example composite dual image video stream 690 including both reverse video stream 670 corresponding to reverse field of view 615 of monitored individual 605 of FIG. 6a and forward video stream 650 corresponding to forward field of view 610 of monitored individual 605 of FIG. 6a is shown. This is an example of a dual image stream combined into a single stream for display that may be assembled in accordance with different embodiments. Returning to FIG. 3, the assembled video stream including images video images from both the forward camera and the reverse camera are displayed on a display (a split screen display showing both video from the forward camera and video from the reverse camera of the user detached monitor device) used by the third party (block 355).

The third party's desire to change to/from only a face image is continually monitored (blocks 315, 335, 360). At any point that the selection is changed from face only to not face only, a command is issued to enable both the forward and reverse cameras are enabled (block 340), and dual video streams are received and displayed (blocks 345, 350, 355). Similarly, at any point that the selection is changed to face only from not face only, a command is issued to disable the reverse camera and only the forward camera is sent (block 320), and only a single video stream is received and displayed (blocks 325, 330).

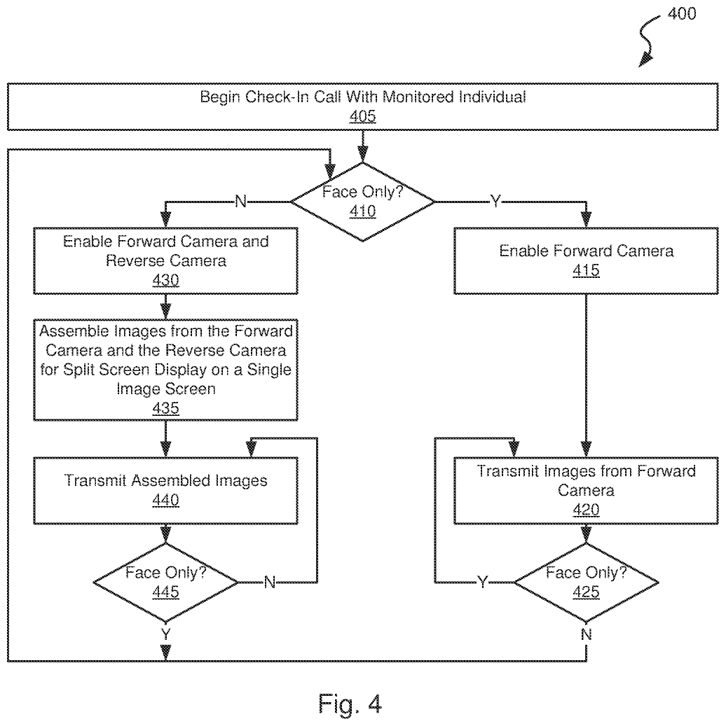

Turning to FIG. 4, a flow diagram 400 shows a method in accordance with some embodiments from the perspective of a user detached monitor device for enabling single video image stream or two video image streams, and transmitting a single video image stream from only the forward camera of the user detached monitor device or a composite video image stream having images from both the forward camera and the reverse camera. Following flow diagram 400, a check-in call is initiated with a monitored individual (block 405). Such a check-in call may be initiated, for example, by a third party calling a user detached monitor device associated with the monitored individual. As another example, such a check-in call may be initiated automatically by a user detached monitor device associated with the monitored individual based upon a check-in schedule maintained in the user detached monitor device. As yet another example, such a check-in call may be initiated by the monitored individual using a user detached monitor device associated with the monitored individual to call a designated third party. Based upon the disclosure provided herein, one of ordinary skill in the art will recognize a variety of approaches that may be used to initiate a check-in in accordance with different embodiments.

It is determined whether the check-in will be performed with images of only the monitored individual's face (block 410). This may be determined, for example, based upon a preset configuration in the user detached monitor device. Alternatively, this may be determined, for example, based upon a command received from the third party with whom the monitored individual is checking in. Such a command from the third party may be directed either directly to the user attached monitor device associated with the monitored individual such that the monitored individual is not involved in the selection, or to the monitored individual who then enters the selection in the user detached monitor device. Based upon the disclosure provided herein, one of ordinary skill in the art will recognize a variety of approaches for determining whether only a face image of the monitored individual is to be used in accordance with different embodiments.

Where only a face image is selected (block 410), a forward camera on the user detached monitor device is enabled (block 415), and a video stream derived from the enabled forward camera is generated by the user detached monitor device and transmitted to the third party with whom the monitored individual is checking in (block 420). Such transmission of images may be done using any approach known in the art. Turning to FIG. 6b, an example forward video stream 650 corresponding to forward field of view 610 of monitored individual 605 of FIG. 6a is shown. This is an example of the single video stream transmitted when face only is selected.

Returning to FIG. 4, where only a face image is not selected (block 410), both the forward camera and a reverse camera on the user detached monitor device are enabled (block 430), and a dual video stream derived from the enabled forward camera and the enabled reverse camera is generated by the user detached monitor device and transmitted to the third party with whom the monitored individual is checking in (block 435). Images from both the forward camera and the reverse camera are combined to yield a single video stream including both the forward field of view provided by the forward camera and the reverse field of view provided by the reverse camera (block 435). Turning to FIG. 6d, example composite dual image video stream 690 including both reverse video stream 670 corresponding to reverse field of view 615 of monitored individual 605 of FIG. 6a and forward video stream 650 corresponding to forward field of view 610 of monitored individual 605 of FIG. 6a is shown. This is an example of a video stream including assembled images from two different cameras that may be transmitted in accordance with different embodiments. Based upon the disclosure provided herein, one of ordinary skill in the art will recognize a variety of approaches for transmitting two video streams in accordance with different embodiments.

Returning to FIG. 4, in other embodiments, the dual video stream may be transmitted as single video stream that is a composite of the video from the enabled forward camera and the video from the enabled reverse camera. In such a situation, the detached monitor device is equipped with a software application that allows for combining two separate video streams into a single composite video stream. Turning to FIG. 6d, an example composite dual image video stream 690 including both reverse video stream 670 corresponding to reverse field of view 615 of monitored individual 605 of FIG. 6a and forward video stream 650 corresponding to forward field of view 610 of monitored individual 605 of FIG. 6a is shown. This is an example of a dual image stream that may be transmitted in accordance with different embodiments. Based upon the disclosure provided herein, one of ordinary skill in the art will recognize a variety of approaches for transmitting two video streams in accordance with different embodiments.

Returning to FIG. 4, the selection of only a face image is continually monitored (blocks 410, 425, 445). At any point that the selection is changed from face only to not face only, both the forward and reverse cameras are enabled (block 430), and a composite of video from both the forward camera and the reverse camera is sent (blocks 435, 440). Similarly, at any point that the selection is changed to face only from not face only, the reverse camera is disabled and only the forward camera is enabled (block 415), and only a single video stream is sent (block 420).

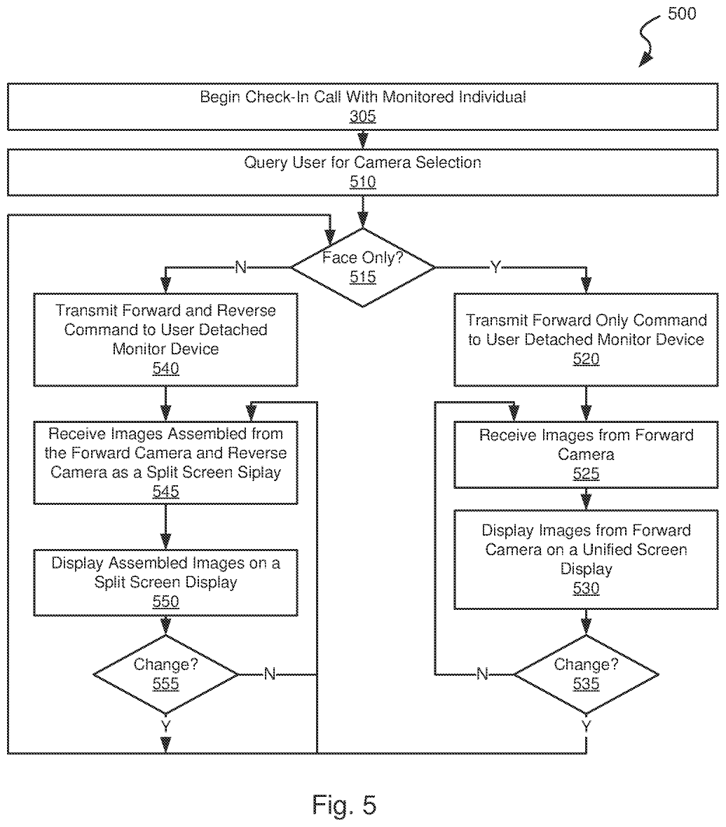

Turning to FIG. 5, a flow diagram 500 shows a method in accordance with some embodiments from the perspective of a monitoring system interacting with the user detached monitor device of FIG. 4. Following flow diagram 500, a check-in call is initiated with a monitored individual (block 505). Such a check-in call may be initiated, for example, by a third party calling a user detached monitor device associated with the monitored individual. As another example, such a check-in call may be initiated automatically by a user detached monitor device associated with the monitored individual based upon a check-in schedule maintained in the user detached monitor device. As yet another example, such a check-in call may be initiated by the monitored individual using a user detached monitor device associated with the monitored individual to call a designated third party. Based upon the disclosure provided herein, one of ordinary skill in the art will recognize a variety of approaches that may be used to initiate a check-in in accordance with different embodiments.

The monitoring system queries the third party performing the monitoring on the monitored individual if they would like a face only monitoring check-in or if they would like more than a face only (block 510). This can be done, for example, by presenting a prompt to a user station accessed by the third party. It is determined whether the check-in will be performed with images of only the monitored individual's face based upon the response to the query provided to the third party (block 515).

Where only a face image is selected (block 515), a command is transmitted to the user detached monitor device used by the monitor individual to enable only the forward camera of the user detached monitor device (block 520). Once the command is implemented by the user detached monitor device, a video stream is received from the forward camera of the user detached monitor device (block 525). Turning to FIG. 6b, example forward video stream 650 corresponding to forward field of view 610 of monitored individual 605 of FIG. 6a is shown. This is an example of the single video stream transmitted when face only is selected. Returning to FIG. 5, the video images from the forward camera are displayed on a display (a unified screen display showing only the single video stream from the forward camera of the user detached monitor device) used by the third party (block 530).

Alternatively, where only a face image is not selected (block 515), a command is transmitted to the user detached monitor device used by the monitor individual to enable both the forward camera and the reverse camera of the user detached monitor device (block 540). Once the command is implemented by the user detached monitor device, a single video stream including images from both the forward camera and the reverse camera of the user detached monitor device is received (block 545). The video streams from each of the forward camera and the reverse camera have been assembled by the user detached monitor device for a split screen display. Turning to FIG. 6d, example composite dual image video stream 690 including both reverse video stream 670 corresponding to reverse field of view 615 of monitored individual 605 of FIG. 6a and forward video stream 650 corresponding to forward field of view 610 of monitored individual 605 of FIG. 6a is shown. This is an example of a dual image stream combined into a single stream for display that may be assembled in accordance with different embodiments. Returning to FIG. 5, the assembled video stream including images video images from both the forward camera and the reverse camera are displayed on a display (a split screen display showing both video from the forward camera and video from the reverse camera of the user detached monitor device) used by the third party (block 550).

The third party's desire to change to/from only a face image is continually monitored (blocks 515, 535, 555). At any point that the selection is changed from face only to not face only, a command is issued to enable both the forward and reverse cameras are enabled (block 540), and a composite of dual video streams is received and displayed (blocks 545, 550). Similarly, at any point that the selection is changed to face only from not face only, a command is issued to disable the reverse camera and only the forward camera is sent (block 520), and only a single video stream is received and displayed (blocks 525, 530).

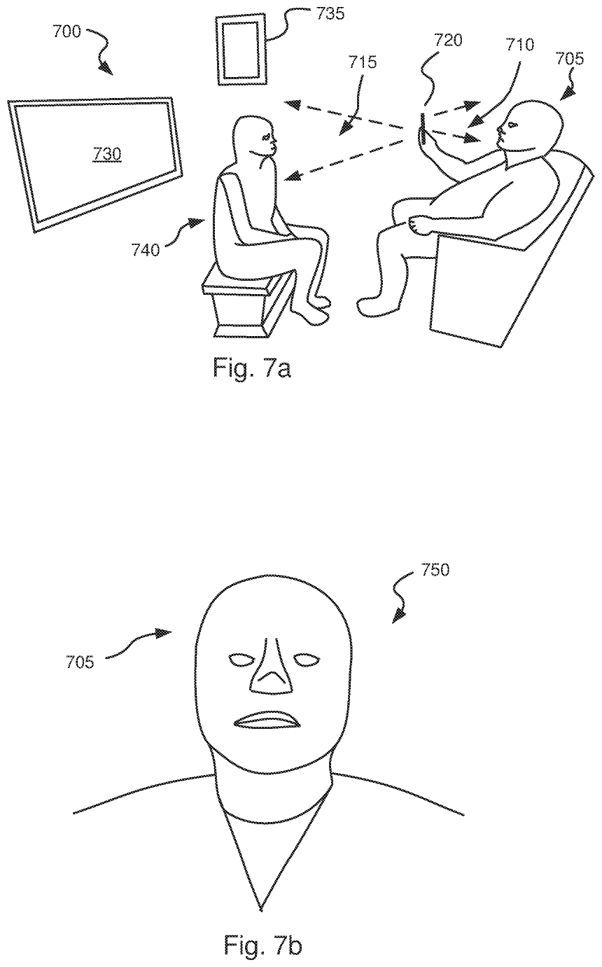

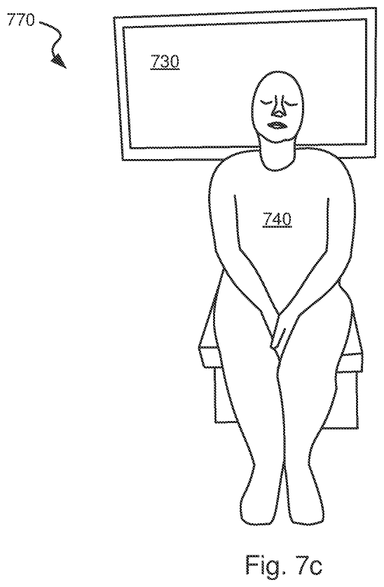

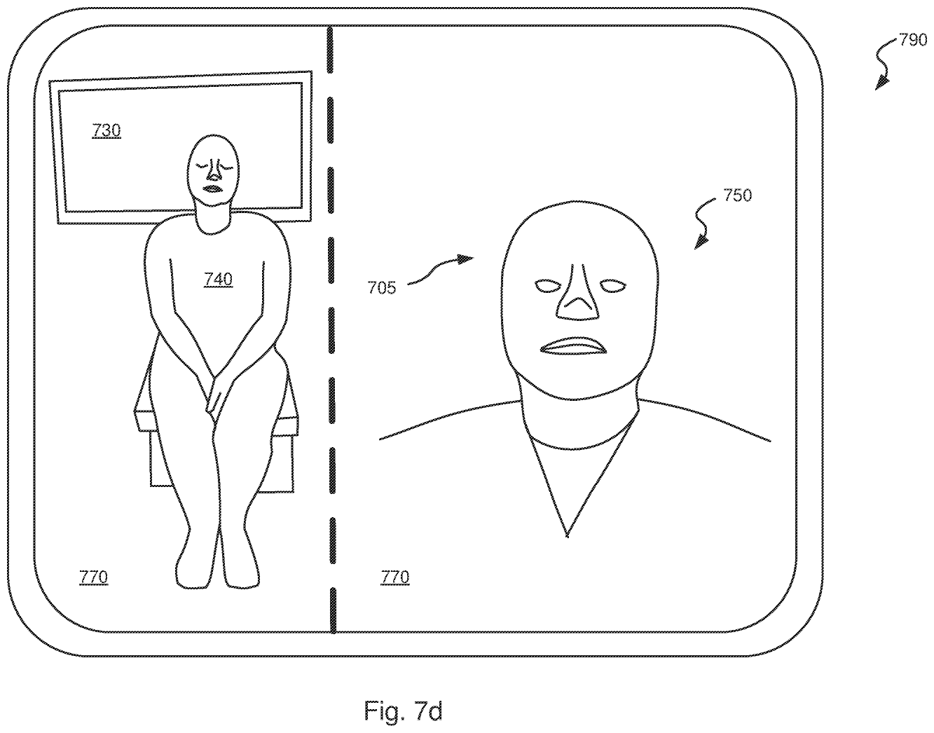

Turning to FIGS. 7a-7d another example scenario is shown including another individual 740 in the room with a monitored individual 705. In this scenario, a reverse camera of a user detached monitor device 720 shows individual 740 within a reverse field of view 715. Turning to FIG. 7a, monitored individual 705 is shown holding user detached monitor device 720 having two cameras, with one of the cameras pointed forward toward the face monitored individual 705 (generating a forward video image stream corresponding to a forward field of view 710) and the other of the two cameras pointed in reverse away from the face of monitored individual 705 (generating a reverse video image stream corresponding to a reverse field of view 715). The forward field of view shows primarily monitored individual 705, and reverse field of view 715 shows various surroundings (e.g., a television 730 and individual 740) of monitored individual 705. A picture 735 is not in either forward field of view 710 or reverse field of view 715.

Turning to FIG. 7b, an example forward video stream 750 corresponding to forward field of view 710 of monitored individual 705 of FIG. 7a is shown. Turning to FIG. 7c, an example reverse video stream 770 corresponding to reverse field of view 715 of monitored individual 705 of FIG. 7a is shown. Turning to FIG. 7d, an example composite dual image video stream 790 including both reverse video stream 770 corresponding to reverse field of view 715 of monitored individual 705 of FIG. 7a and forward video stream 750 corresponding to forward field of view 710 of monitored individual 705 of FIG. 7a is shown.

While embodiments are discussed as using a forward video image stream and a reverse video image stream from a forward camera and a reverse camera, respectively, it is noted that other embodiments may include three or more cameras all of which may be used and/or two cameras arranged in other than the forward and reverse configuration discussed herein. Further, selection between cameras may include selection of a particular characteristic of a selected camera including, but not limited to, a telephoto camera characteristic and a wider angle lens view characteristic.

In conclusion, the present invention provides for novel systems, devices, and methods for monitoring individuals. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A system for monitoring an individual, the system comprising:
a user detached monitor device, wherein the user detached monitor device includes:
a first camera facing a first direction relative to the user detached monitor device;
a second camera facing a second direction relative to the user detached monitor device;
a processor; and
a computer readable medium including instructions executable by the processor to:
receive a command, wherein the command indicates either single camera operation or dual camera operation;
transmit a first video image stream from the first camera when the command indicates single camera operation; and
transmit a second video image stream derived from the first camera and the second camera when the command indicates dual camera operation.

2. The system of claim 1, wherein transmitting the second video image stream derived from the first camera and the second camera includes combining a video image stream from the first camera with a video image stream from the second camera to yield a split screen video image stream.

3. The system of claim 2, wherein the split screen video image stream includes approximately even portions of the video image stream from the first camera and the video image stream from the second camera.

4. The system of claim 2, wherein the split screen video image stream includes one of the video image stream from the first camera or the video image stream from the second camera as a picture-in-picture overlay on the other of the video image stream from the first camera or the video image stream.

5. The system of claim 1, wherein transmitting the second video image stream derived from the first camera and the second camera includes:
transmitting both the first video image stream from the first camera and a third video image stream from the second camera as separate video streams.

6. The system of claim 1, wherein the first direction is approximately 180 degrees from the second direction.

7. A method for monitoring an individual, the method comprising:
receiving, by a processing resource of a user detached monitor device, an indication of either single camera operation or dual camera operation;
transmitting, by the processing resource of the user detached monitor device, a first video image stream from a first camera of a user detached monitor device when the command indicates single camera operation;
transmitting, by the processing resource of the user detached monitor device, a second video image stream derived from the first camera and the second camera of the user detached monitor device when the command indicates dual camera operation, wherein the first camera is directed in a first direction and the second camera is directed in a second direction.

8. The method of claim 7, wherein the indication is selected from a group consisting of: an input from a monitored individual associated with the user detached monitor device; a command received from a third party assigned to monitor the monitored individual, and a preset field in the user detached monitor device.

9. The method of claim 7, wherein transmitting the second video image stream derived from the first camera and the second camera includes combining a video image stream from the first camera with a video image stream from the second camera to yield a split screen video image stream.

10. The method of claim 9, wherein the split screen video image stream includes approximately even portions of the video image stream from the first camera and the video image stream from the second camera.

11. The method of claim 9, wherein the split screen video image stream includes one of the video image stream from the first camera or the video image stream from the second camera as a picture-in-picture overlay on the other of the video image stream from the first camera or the video image stream.

12. The method of claim 7, wherein transmitting the second video image stream derived from the first camera and the second camera includes:
transmitting both the first video image stream from the first camera and a third video image stream from the second camera.

13. The method of claim 7, wherein the first direction is approximately 180 degrees from the second direction.

14. A system for monitoring an individual, the system comprising:
a user detached monitor device, wherein the user detached monitor device includes:
a first camera facing a first direction relative to the user detached monitor device;
a second camera facing a second direction relative to the user detached monitor device;
a processor; and
a computer readable medium including instructions executable by the processor to:
select processing using only a single video stream or multiple video streams based upon an input;
transmit a first video image stream from the first camera when the command indicates single camera operation; and
transmit a second video image stream derived from the first camera and the second camera when the command indicates dual camera operation.

15. The system of claim 14, wherein the input is selected from a group consisting of: an input from a monitored individual associated with the user detached monitor device; a command received from a third party assigned to monitor the monitored individual, and a preset field in the user detached monitor device.

16. The system of claim 14, wherein transmitting the second video image stream derived from the first camera and the second camera includes combining a video image stream from the first camera with a video image stream from the second camera to yield a split screen video image stream.

17. The system of claim 16, wherein the split screen video image stream includes approximately even portions of the video image stream from the first camera and the video image stream from the second camera.

18. The system of claim 16, wherein the split screen video image stream includes one of the video image stream from the first camera or the video image stream from the second camera as a picture-in-picture overlay on the other of the video image stream from the first camera or the video image stream.

19. The system of claim 14, wherein transmitting the second video image stream derived from the first camera and the second camera includes:
transmitting both the first video image stream from the first camera and a third video image stream from the second camera as separate video streams.

20. The system of claim 14, wherein the first direction is approximately 180 degrees from the second direction.
